(19) United States
(12) Patent Application Publication
(10) Pub. No.: US 2015/0188184 A1
(43) Pub. Date: Jul. 2, 2015

(54) NON-AQUEOUS ELECTROLYTIC SECONDARY BATTERY AND MANUFACTURING METHOD OF NON-AQUEOUS ELECTROLYTIC SECONDARY BATTERY

(71) Applicant: SANYO Electric Co., Ltd., Osaka (JP)

(72) Inventors: Keisuke MINAMI, Kakogawa-shi (JP); Toyoki FUJIHARA, Kanzaki-gun (JP)

(21) Appl. No.: 14/582,945

(22) Filed: Dec. 24, 2014

(30) Foreign Application Priority Data
Dec. 26, 2013 (JP) 2013-268671

(51) Int. Cl. H01M 10/04; H01M 10/0525; H01M 4/62; H01M 4/485; H01M 2/08

(52) U.S. Cl. CPC H01M 10/0431; H01M 4/485; H01M 2/08; H01M 4/625; H01M 4/623; H01M 10/0525; H01M 10/049; H01M 2220/20

(57) ABSTRACT

A non-aqueous electrolytic secondary battery is provided having an electrode assembly having a positive electrode plate on which a positive electrode mixture layer is formed over a surface of a positive electrode core, and a negative electrode plate on which a negative electrode mixture layer is formed over a surface of a negative electrode core, and a non-aqueous electrolyte, wherein the positive electrode mixture layer includes a lithium transition metal complex oxide, the negative electrode mixture layer includes a negative electrode active material to and from which lithium ions may be introduced and extracted, a thickness of the positive electrode plate is less than or equal to 60 μm, a thickness of the negative electrode plate is less than or equal to 65 μm, a ratio of a thickness of the positive electrode core with respect to the thickness of the positive electrode plate is 22˜27%, and a ratio of a thickness of the negative electrode core with respect to the thickness of the negative electrode plate is 12˜15%.

### PRIORITY INFORMATION

This application claims priority to Japanese Patent Application No. 2013-268671, filed on Dec. 26, 2013, which is incorporated herein by reference in its entirety.

### BACKGROUND

1. Technical Field

The present invention relates to a non-aqueous electrolytic secondary battery, and a manufacturing method of a non-aqueous electrolytic secondary battery.

2. Related Art

In recent years, a non-aqueous electrolytic secondary battery having a high energy density is used for a driving power supply or the like for a hybrid electric vehicle (PHEV, HEV), or an electric vehicle. A demand for higher performance is growing higher for the non-aqueous electrolytic secondary battery used for the driving power supply or the like.

In JP 2006-277990 A, JP 2006-216395 A, JP 2006-260786 A, and JP H11-329409 A, thicknesses of positive and negative electrode plates, a thickness of a combination layer, or the like, are reviewed.

In the non-aqueous electrolytic secondary battery disclosed in JP 2006-277990 A, JP 2006-216395 A, JP 2006-260786 A, and JP H11-329409 A, the battery characteristic is not sufficient as a non-aqueous electrolytic secondary battery used for the driving power supply or the like of a hybrid electric vehicle and electric vehicle. An advantage of the present invention is that a non-aqueous electrolytic secondary battery is provided having a superior power characteristic.

### SUMMARY

According to one aspect of the present invention, there is provided a non-aqueous electrolytic secondary battery comprising: an electrode assembly having a positive electrode plate in which a positive electrode mixture layer is formed over a surface of a positive electrode core, and a negative electrode plate in which a negative electrode mixture layer is formed over a surface of a negative electrode core; and a non-aqueous electrolyte, wherein the positive electrode mixture layer includes a lithium transition metal complex oxide, the negative electrode mixture layer includes a negative electrode active material to and from which lithium ions may be introduced and extracted, a thickness of the positive electrode plate is less than or equal to 60 μm, a thickness of the negative electrode plate is less than or equal to 65 μm, a ratio of a thickness of the positive electrode core with respect to the thickness of the positive electrode plate is 22˜27%, and a ratio of a thickness of the negative electrode core with respect to the thickness of the negative electrode plate is 12˜15%.

### Advantages

According to the non-aqueous electrolytic secondary battery of one aspect of the present invention, the thickness of the positive electrode plate, the thickness of the negative electrode plate, the ratio of the thickness of the positive electrode core with respect to the thickness of the positive electrode plate, and the ratio of the thickness of the negative electrode core with respect to the thickness of the negative electrode plate are defined in particular ranges, so that a non-aqueous electrolytic secondary battery having a superior power characteristic is provided.

According to another aspect of the present invention, preferably, in the non-aqueous electrolytic secondary battery, the electrode assembly is a flat-shaped winding electrode assembly in which the positive electrode plate and the negative electrode plate are wound with a separator therebetween, and the non-aqueous electrolytic secondary battery further comprises: a rectangular outer housing that has a tubular shape with a bottom, that has an opening, and that houses the electrode assembly and the non-aqueous electrolyte; and a sealing plate that seals the opening, the rectangular outer housing comprising a pair of large-area side walls and a pair of small-area side walls having a smaller area than the large-area side wall, and a value of a number of layers of the positive electrode plate in the electrode assembly placed between the pair of the large-area side walls with respect to a distance between the pair of the large-area side walls being greater than or equal to 5 layers/mm. With such a configuration, a non-aqueous electrolytic secondary battery having a more superior power characteristic can be provided.

According to another aspect of the present invention, preferably, in the non-aqueous electrolytic secondary battery, an average particle size of the lithium transition metal complex oxide is 1˜12 μm, the negative electrode mixture layer includes a carbon material as the negative electrode active material, and an average particle size of the carbon material is 4˜15 μm. With such a configuration, a non-aqueous electrolytic secondary battery having a more superior power characteristic can be provided.

According to another aspect of the present invention, preferably, in the non-aqueous electrolytic secondary battery, a filling density of the positive electrode mixture layer is 2.2˜3.0 g/cm³, and a filling density of the negative electrode mixture layer is 0.9˜1.5 g/cm³. With such a configuration, a non-aqueous electrolytic secondary battery having a more superior power characteristic can be provided.

According to another aspect of the present invention, preferably, in the non-aqueous electrolytic secondary battery, a thickness of the flat-shaped winding electrode assembly is greater than or equal to 10 mm. This configuration is particularly effective.

According to another aspect of the present invention, preferably, in the non-aqueous electrolytic secondary battery, the positive electrode mixture layer includes an electricity conducting agent made of a carbon material, and a content of the electricity conducting agent in the positive electrode mixture layer is greater than or equal to 5 weight %. With such a configuration, a non-aqueous electrolytic secondary battery having a more superior power characteristic can be provided.

### BRIEF DESCRIPTION OF THE DRAWINGS

FIG. 1 is a perspective diagram of a non-aqueous electrolytic secondary battery according to a preferred embodiment of the present invention.

FIG. 2A is a cross sectional diagram along a line IIA-IIA of FIG. 1.

FIG. 2B is a cross sectional diagram along a line IIB-IIB of FIG. 2A.

FIG. 3A is a plan view of a positive electrode plate used in the non-aqueous electrolytic secondary battery according to a preferred embodiment of the present invention.

FIG. 3B is a cross sectional diagram along a line IIIB-IIIB of FIG. 3A.

FIG. 4A is a plan view of a negative electrode plate used in the non-aqueous electrolytic secondary battery according to a preferred embodiment of the present invention.

FIG. 4B is a cross sectional diagram along a line IVB-IVB of FIG. 4A.

FIG. 5 is a cross sectional diagram along a line IV-IV of FIG. 2A.

### DESCRIPTION OF EXEMPLARY EMBODIMENTS

A preferred embodiment of the present invention will now be described in detail. The preferred embodiment(s) described below is merely exemplary for understanding of the technical idea of the present invention, and is not intended to limit the present invention to the particular embodiment(s) described herein.

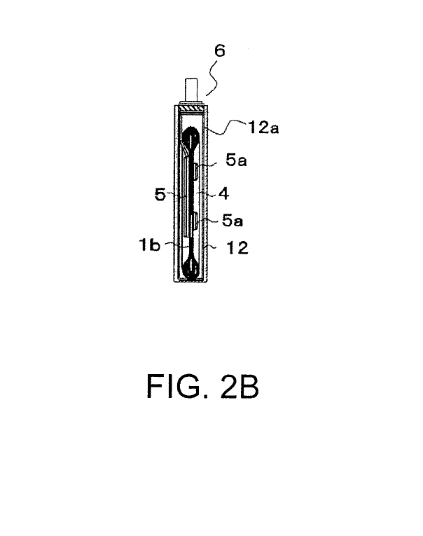

As shown in FIG. 2, a non-aqueous electrolytic secondary battery has a flat-shaped winding electrode assembly 4 in which a positive electrode plate 1 and a negative electrode plate 2 are wound with a separator 3 therebetween. The outermost circumferential surface of the flat-shaped winding electrode assembly 4 is covered by the separator 3.

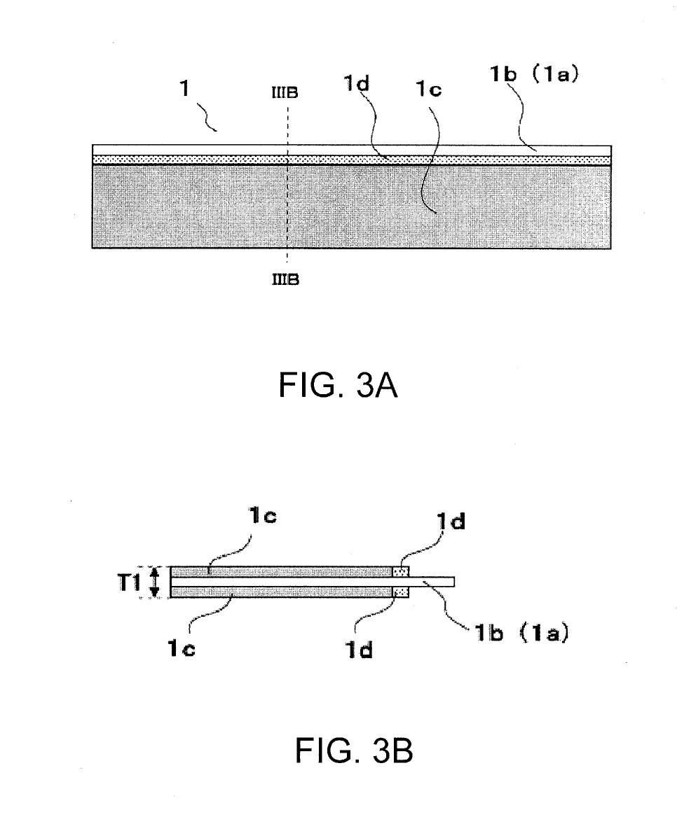

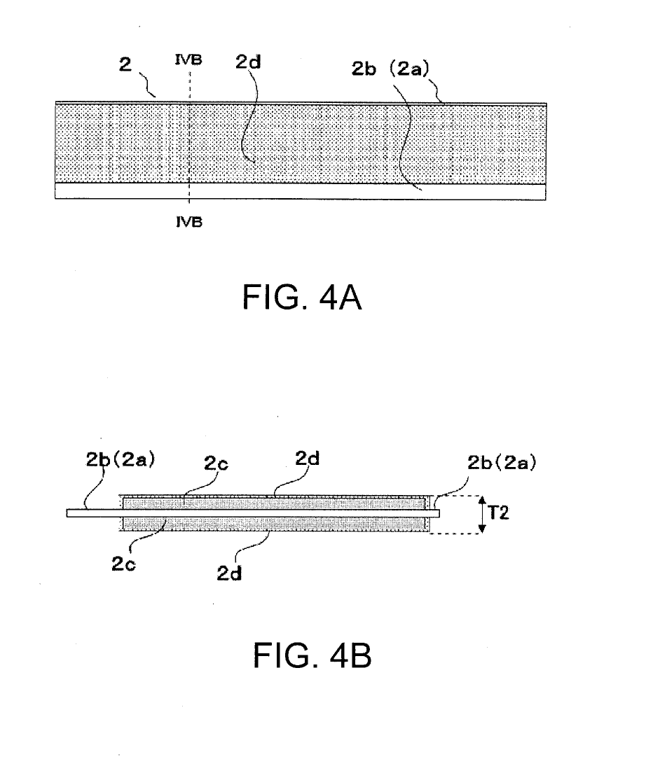

As shown in FIG. 3, in the positive electrode plate 1. a positive electrode mixture layer 1c is formed over both surfaces of a positive electrode core 1a made of aluminum or an aluminum alloy such that positive electrode core exposed portions 1b where a core is exposed in a band shape along a longitudinal direction at an end of one side in a width direction are formed over both surfaces. Over the positive electrode core 1a near the end of the positive electrode mixture layer 1c, a positive electrode protection layer 1d is formed. As shown in FIG. 4, in the negative electrode plate 2, a negative electrode mixture layer 2c is formed over both surfaces of a negative electrode core 2a made of copper or a copper alloy such that negative electrode core exposed portions 2b where a core is exposed in a band shape along a longitudinal direction on both ends in a width direction are formed over both surfaces. A negative electrode protection layer 2d is formed over the negative electrode mixture layer 2c. A width of the negative electrode core exposed portion 2b provided on one end in the width direction of the negative electrode plate 2 is wider than a width of the negative electrode core exposed portion 2b provided on the other end in the width direction of the negative electrode plate 2. Alternatively, the negative electrode core exposed portion 2b may be provided on only one end in the width direction of the negative electrode plate 2.

The positive electrode plate 1 and the negative electrode plate 2 are wound with the separator 3 therebetween, and formed in a flat shape, so that the flat-shaped winding electrode assembly 4 is produced. In this process, the positive electrode core exposed portion 1b which is wound is formed on one end of the flat-shaped winding electrode assembly 4, and the negative electrode core exposed potion 2b which is wound is formed on the other end.

As shown in FIG. 2, the wound positive electrode core exposed portion 1b is electrically connected to a positive electrode terminal 6 via a positive electrode electricity collector 5. The wound negative electrode core exposed portion 2b is electrically connected to a negative electrode terminal 8 via a negative electrode electricity collector 7. The positive electrode electricity collector 5 and the positive electrode terminal 6 are preferably made of aluminum or an aluminum alloy. The negative electrode electricity collector 7 and the negative electrode terminal 8 are preferably made of copper or a copper alloy. The positive electrode terminal 6 may include a connection section 6a penetrating through a sealing plate 11 made of a metal, a plate-shaped section 6b placed on an outer surface side of the sealing plate 11, and a bolt section 6c provided over the plate-shaped section 6b. The negative electrode terminal 8 preferably includes a connection section 8a penetrating through the sealing plate 11, a plate-shaped section 8b placed at an outer surface side of the sealing plate 11, and a bolt section 8c provided over the plate-shaped section 8b.

On an electricity conduction path between the positive electrode plate 1 and the positive electrode terminal 6, a current disconnection mechanism 16 is provided which is activated when an inner pressure of the battery becomes larger than a predetermined value to disconnect the electricity conduction path between the positive electrode plate 1 and the positive electrode terminal 6.

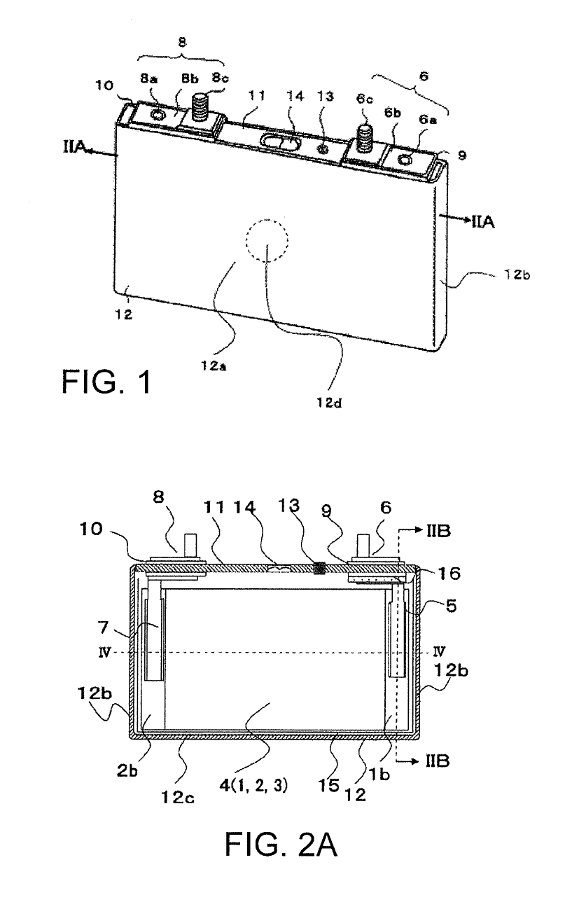

As shown in FIGS. 1 and 2A, the positive electrode terminal 6 is fixed on the sealing plate 11 with an insulating member 9 therebetween. The negative electrode terminal 8 is fixed on the sealing plate 11 with an insulating member 10 therebetween.

The flat-shaped winding electrode assembly 4 is housed in a rectangular outer housing 12 made of a metal in a state of being covered with an insulating sheet 15 made of a resin. The sealing plate 11 is contacted to an opening of the rectangular outer housing 12, and the contact section between the sealing plate 11 and the rectangular outer housing 12 is laser-welded.

The rectangular outer housing 12 has a tubular shape with a bottom, and includes a pair of large-area side walls 12a, a pair of small-area side walls 12b having a smaller area than the large-area side walls 12a, and a bottom 12c. On a flat section of the flat-shaped winding electrode assembly 4, a pair of flat outer surfaces are placed to oppose the pair of the large-area side walls 12a, respectively.

The sealing plate 11 has an electrolytic solution injection hole 13, a non-aqueous electrolytic solution is introduced through the electrolytic solution injection hole 13, and then, the electrolytic solution injection hole 13 is sealed by a blind rivet or the like. On the sealing plate 11, a gas discharge valve 14 is formed which breaks when an inner pressure of the battery becomes a larger value than an activation pressure of the current disconnection mechanism 16 to discharge the gas inside the battery to the outside of the battery.

Next, manufacturing methods of the positive electrode plate 1, the negative electrode plate 2, the flat-shaped winding electrode assembly 4, and non-aqueous electrolytic solution serving as the non-aqueous electrolyte in the non-aqueous electrolytic secondary battery will be described.

### [Production of Positive Electrode Plate]

As the positive electrode active material, a lithium transition metal complex oxide represented by Li(Ni_{0.35}CO_{0.35}Mn_{0.30})_{0.95}Zr_{0.05}O₂ and having an average particles size of 3 μm was used. The positive electrode active material, a carbon powder serving as an electricity conducting agent, polyvinylidene fluoride (PVdF) serving as binding agent, and N-methyl-2-pyrrolidone (NMP) serving as a dispersing medium were mixed in an amount in mass ratio of 61:5:1:33, to produce a positive electrode mixture slurry.

An alumina powder, the PVdF, a carbon powder, and the NMP serving as the dispersing medium were mixed in an amount in mass ratio of 21:4:1:74, to produce a positive electrode protection layer slurry.

The positive electrode mixture slurry produced by the above-described method was applied on both surfaces of an aluminum foil serving as the positive electrode core 1a by a die coater. Then, the positive electrode protection layer slurry produced by the above-described method was applied over the positive electrode core 1a at an end of the region in which the positive electrode mixture slurry was applied. Then, the electrode plate was dried to remove the NMP serving as the dispersing medium, and the structure was compressed by a roll press to a predetermined thickness. The resulting structure was cut in a predetermined size such that the positive electrode core exposed portion 1b in which the positive electrode mixture layer 1c was not formed on both surfaces along a longitudinal direction was formed on one end in a width direction of the positive electrode plate 1, to form the positive electrode plate 1. An area in a plan view of the positive electrode core 1a on which the positive electrode mixture layer 1c was formed on both surfaces was 0.42 m². A thickness of the positive electrode protection layer 1d was set lower than a thickness of the positive electrode mixture layer 1c.

### [Production of Negative Electrode Plate]

A graphite powder serving as the negative electrode active material and having an average particle size of 10 μm, carboxymethyl cellulose (CMC) serving as a viscosity enhancing agent, styrene-butadiene rubber (SBR) serving as a binding agent, and water serving as a dispersing medium were mixed in an amount in a mass ratio of 40.8:0.4:0.1:58.7, to produce a negative electrode mixture slurry.

An alumina powder, a binding agent (acrylic resin) , and the NMP serving as a dispersing medium were mixed in an amount in mass ratio of 30:0.9:69.1, to produce a negative electrode protection layer slurry to which a mixture dispersion process was applied by a bead mill.

The negative electrode mixture slurry produced by the above-described method was applied to both surfaces of a copper foil serving as the negative electrode core 2a by a die coater. Then, the structure was dried to remove the water serving as the dispersing medium, and was compressed by a roll press to a predetermined thickness. Then, the negative electrode protection layer slurry produced by the above-described method was applied over the negative electrode mixture layer 2c, and the NMP used as a solvent was dried and removed, to produce the negative electrode protection layer. Then, the structure was cut in a predetermined size such that the negative electrode core exposed portion 2b in which the negative electrode mixture layer 2c was not formed on both surfaces along a longitudinal direction was formed on both ends in a width direction of the negative electrode plate, to produce the negative electrode plate 2. An area in the plan view of the negative electrode core 2a on which the negative electrode mixture layer 2c was formed on both surfaces was 0.44 m².

### [Production of Flat-Shaped Winding Electrode Assembly]

The positive electrode plate 1 and the negative electrode plate 2 produced by the above-described methods were wound with the separator 3 made of polypropylene and having a thickness of 20 μm therebetween, and then, press-molded in a flat shape, to produce the flat-shaped winding electrode assembly 4. This process was executed in a manner such that, on one end in a winding axis direction of the flat-shaped winding electrode assembly 4, the wound positive electrode core exposed portion 1b was formed, and on the other end, the negative electrode core exposed portion 2b was formed. The separator 3 was positioned at the outermost circumference of the flat-shaped winding electrode assembly 4. In addition, a winding termination end of the negative electrode plate 2 was positioned at an circumferential side further out than a winding termination end of the positive electrode plate 1. A thickness at a center section of the flat section of the flat-shaped winding electrode assembly 4 was 11.1 mm.

Here, in the flat-shaped winding electrode assembly 4, a thickness T1 of the positive electrode plate 1 was 58 μm, a thickness of the positive electrode core 1a was 15 μm, and a thickness of the positive electrode mixture layer 1c was 43 μm (21.5 μm on each side). A filling density of the positive electrode mixture layer was 2.47 g/cm³. In the flat-shaped winding electrode assembly 4, a thickness T2 of the negative electrode plate 2 was 60 μm, a thickness of the negative electrode core 2a was 8 μm, a thickness of the negative electrode mixture layer 2c was 48 μm (24 μm on each side) , and a thickness of the negative electrode protection layer 2d was 4 μm (2 μm on each side). A filling density of the negative electrode mixture layer was 1.13 g/cm³. The thicknesses related to the positive electrode plate 1 and the negative electrode plate 2 refer to values at the flat section (portion placed between a center section 12d of one large-area side wall 12a and a center section 12d of the other large-area side wall 12a) of the flat-shaped winding electrode assembly 4.

### [Preparation of Non-Aqueous Electrolytic Solution]

A mixture solvent was produced in which ethylene carbonate (EC), ethylmethyl carbonate (EMC), and diethyl carbonate (DEC) were mixed in a volume ratio (25° C., 1 atmosphere) of 3:3:4. To this mixture solvent, LiPF₆ was added to a concentration of 1 mol/L, and 0.3 weight % of vinylene carbonate (VC) with respect to the total mass of the non-aqueous electrolyte was added, to produce a non-aqueous electrolytic solution.

### [Assembly of Non-Aqueous Electrolytic Secondary Battery]

The positive electrode terminal 6 and the positive electrode electricity collector 5 were electrically connected, and were fixed on the sealing plate 11 made of aluminum with the insulating member 9 therebetween. In addition, the current disconnection mechanism 16 that disconnects the electricity conduction path between the positive electrode terminal 6 and the positive electrode electricity collector 5 with an increase of an internal pressure of the battery was provided between the positive electrode terminal 6 and the positive electrode electricity collector 5. The negative electrode terminal 8 and the negative electrode electricity collector 7 were electrically connected, and were fixed on the sealing plate 11 with the insulating member 10 therebetween. Then, the positive electrode electricity collector 5 and a mounting component 5a were connected to the outermost surface of the wound positive electrode core exposed portion 1b, and the negative electrode electricity collector 7 and a mounting component were connected to the outermost surface of the negative electrode core exposed portion 2b.

Then, the flat-shaped winding electrode assembly 4 was covered with the insulating sheet 15 made of polypropylene and folded and molded in a box shape, and the resulting structure was inserted into the rectangular outer housing 12 made of aluminum. The contact section between the rectangular outer housing 12 and the sealing plate 11 were laser-welded, to seal the opening of the rectangular outer housing 12.

After the non-aqueous electrolytic solution produced by the above-described method was introduced from the electrolytic solution injection hole 13 of the sealing plate 11, the electrolytic solution injection hole 13 was sealed with a blind rivet. The non-aqueous electrolytic secondary battery of the present embodiment was set as a battery I.

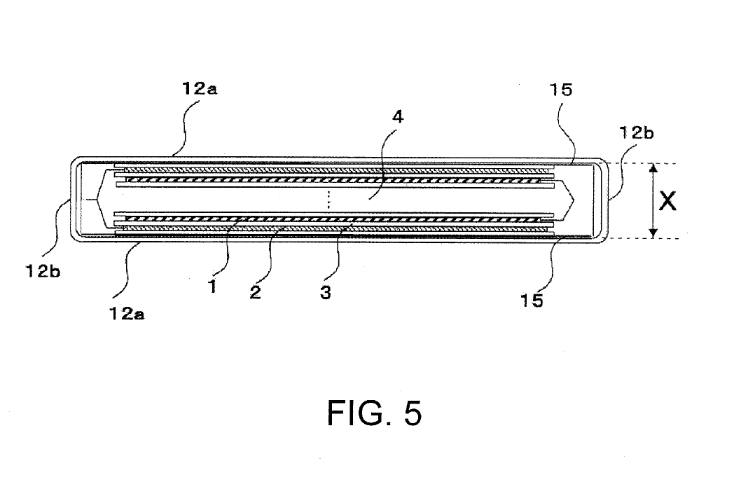

As shown in FIG. 5, in the battery I, a distance X between the pair of the large-area side walls 12a of the rectangular outer housing 12 was 12.5 mm, a number of layers Y of the positive electrode plate 1 in the flat-shaped winding electrode assembly 4 placed between the pair of the large-area side walls 12a of the rectangular outer housing 12 was 68 layers, and Y/X was 5.4 layers/mm. A thickness of a portion, of the flat-shaped winding electrode assembly 4, placed between the center section 12d of one large-area side wall 12a and the center section 12d of the other large-area side wall 12a was 11.1 mm. The distance X between the pair of the large-area side walls 12a refers to a distance between the center section 12d of one large-area side wall 12a and the center section 12d of the other large-area side wall 12a. The number of layers Y of the positive electrode plate 1 in the flat-shaped winding electrode assembly 4 placed between the pair of the large-area side walls 12a refers to the number of layers of the positive electrode plate 1 existing between the center section 12d of one large-area side wall 12a and the center section 12d of the other large-area side wall 12a.

In the battery I, a ratio of a total thickness (4.20 mm) of the negative electrode plate 2 in the flat-shaped winding electrode assembly 4 placed between the pair of the large-area side walls 12a of the rectangular outer housing 12 with respect to a total thickness (3.94 mm) of the positive electrode plate 1 in the flat-shaped winding electrode assembly 4 placed between the pair of the large-area side walls 12a of the rectangular outer housing 12 was 107%. In addition, in the battery I, a ratio of a total thickness (2.96 mm) of the separator 3 in the flat-shaped winding electrode assembly 4 placed between the pair of the large-area side walls 12a of the rectangular outer housing 12 with respect to a total thickness (3.94 mm) of the positive electrode plate 1 in the flat-shaped winding electrode assembly 4 placed between the pair of the large-area side walls 12a of the rectangular outer housing 12 was 75%. The total thickness of the positive electrode plate 1, the total thickness of the negative electrode plate 2, and the total thickness of the separator 3 in the flat-shaped winding electrode assembly 4 placed between the pair of the large-area side walls 12a of the rectangular outer housing 12 are respectively the total thicknesses of the positive electrode plate 1, the negative electrode plate 2, and the separator 3 existing between the center section 12d of one large-area side wall 12a and the center section 12d of the other large-area side wall 12a.

A positive electrode plate and a negative electrode plate differing in thickness of the positive electrode plate, thickness of the positive electrode core, thickness of the negative electrode plate, and thickness of the negative electrode core than compared to the battery I were produced, and electrode assemblies of a size that can be housed in the rectangular outer housing 12 used in the battery I were produced, and set as batteries II˜V.

For the batteries I˜V produced as described above, the power characteristic was measured through the following method.

### [Measurement of Power Characteristic]

The battery was charged to a state of charge of 60% at a constant current of 1 C at 25° C. The battery was discharged at 36 C at 25° C., and a voltage at 10th second was measured. A current value at 3 V was calculated based on a current-voltage line, and a value obtained by this current value ×3 V was set as the power (W).

TABLE 1 shows results of the measurement of a power characteristic. TABLE 1 shows a relative value (%) with the power (W) of the battery I being 100%.

TABLE 1

| | | | POSITIVE | | | NEGATIVE | | | |
|---|---|---|---|---|---|---|---|---|---|
| | | | ELECTRODE | | | ELECTRODE | | | |
| | POSITIVE | POSITIVE | CORE | NEGATIVE | NEGATIVE | CORE | | | |
| | ELEC- | ELEC- | THICKNESS/ | ELEC- | ELEC- | THICKNESS/ | POSITIVE | NEGATIVE | |
| | TRODE | TRODE | POSITIVE | TRODE | TRODE | NEGATIVE | ELECTRODE | ELECTRODE | |
| | PLATE | CORE | ELECTRODE | PLATE | CORE | ELECTRODE | MIXTUR | MIXTURE | |
| | THICK- | THICK- | PLATE | THICK- | THICK- | PLATE | LAYER | LAYER | |
| | NESS | NESS | THICKNESS | NESS | NESS | THICKNESS | FORMATION | FORMATION | POWER |
| | (μm) | (μm) | (%) | (μm) | (μm) | (%) | AREA (m²) | AREA (m²) | (%) |
| BATTERY I | 58 | 15 | 25.9 | 60 | 8 | 13.3 | 0.42 | 0.44 | 100 |
| BATTERY II | 69 | 15 | 21.7 | 68 | 9 | 13.0 | 0.34 | 0.36 | 81 |
| BATTERY III | 79 | 15 | 19.0 | 83 | 10 | 12.0 | 0.33 | 0.35 | 79 |
| BATTERY IV | 108 | 15 | 13.9 | 111 | 10 | 9.0 | 0.26 | 0.28 | 62 |
| BATTERY V | 145 | 15 | 10.3 | 127 | 10 | 7.9 | 0.21 | 0.22 | 50 |

As shown in TABLE 1, when the thickness of the positive electrode plate 1 was less than or equal to 60 μm, the thickness of the negative electrode plate 2 was less than or equal to 65 μm, the ratio of the thickness of the positive electrode core 1a with respect to the thickness of the positive electrode plate 1 was 22˜27%, and the ratio of the thickness of the negative electrode core 2a with respect to the thickness of the negative electrode plate 2 was 12˜15%, a non-aqueous electrolytic secondary battery having a superior power characteristic can be obtained.

### <Other Inventions>

According to another aspect of the present invention, there is provided a method of manufacturing a non-aqueous electrolytic secondary battery comprising: an electrode assembly having a positive electrode plate in which a positive electrode mixture layer is formed over a surface of a positive electrode core, and a negative electrode plate in which a negative electrode mixture layer is formed over a surface of a negative electrode core; and a non-aqueous electrolyte, wherein the positive electrode mixture layer includes a lithium transition metal complex oxide, and the negative electrode mixture layer includes a negative electrode active material to and from which lithium ions may be introduced and extracted, the method comprising: a step of applying a positive electrode mixture slurry over the surface of the positive electrode core, wherein the positive electrode mixture slurry includes the positive electrode active material, a binding agent, an electricity conducting agent, and a positive electrode dispersing medium, with a ratio of the positive electrode dispersing medium in the positive electrode mixture slurry being 20˜40 weight %, and a step of applying a negative electrode mixture slurry over the surface of the negative electrode core, wherein the negative electrode mixture slurry includes the negative electrode active material, a binding agent, and a negative electrode dispersing medium, and a ratio of the negative electrode dispersing medium in the negative electrode mixture slurry is 50˜70 weight %.

According to the above-described manufacturing method, because a positive electrode plate and a negative electrode plate of a high quality can be effectively obtained, a non-aqueous electrolytic secondary battery can be obtained having a superior power characteristic and a superior productivity. Such a method is particularly effective when a thickness of the positive electrode plate is less than or equal to 60 μm, a thickness of the negative electrode plate is less than or equal to 65 μm, a ratio of a thickness of the positive electrode core with respect to the thickness of the positive electrode plate is 22˜27%, and the ratio of a thickness of the negative electrode core with respect to the thickness of the negative electrode plate is 12˜15%. However, a non-aqueous electrolytic secondary battery having a superior power characteristic and a superior productivity can be obtained in cases other than the case where the thickness of the positive electrode plate is less than or equal to 60 μm, the thickness of the negative electrode plate is less than or equal to 65 μm, the ratio of the thickness of the positive electrode core with respect to the thickness of the positive electrode plate is 22˜27%, and the ratio of the thickness of the negative electrode core with respect to the thickness of the negative electrode plate is 12˜15%. It is particularly preferable that the positive electrode active material is a lithium transition metal complex oxide, the positive electrode binding agent is polyvinylidene fluoride, the positive electrode electricity conducting agent is a carbon material, the positive electrode dispersing medium is N-methyl-2-pyrrolidone, the negative electrode active material is a carbon material, the negative electrode binding agent is styrene-butadiene rubber, and the negative electrode dispersing medium is water.

### <Others>

As the positive electrode active material, lithium transition metal complex oxides may be preferably used. As the lithium transition metal complex oxide, lithium cobalt oxide (LiCoO₂), lithium manganate (LiMn₂O₄), lithium nickel oxide (LiNiO₂), lithium nickel manganese complex oxide (LiNi₁₋ₓMnₓO₂(0<x<1)), lithium nickel cobalt complex oxide (LiNi₁₋ₓCoₓO₂(0<x<1)), and lithium nickel cobalt manganese complex oxide (LiNiₓCo_{y}Mn_{z}O₂ (0<x<1, 0<z<1, x+y+z=1)) are particularly preferable. In addition, the above-described lithium transition metal complex oxide doped with Al, Ti, Zr, Nb, B, W, Mg, or Mo or the like may alternatively be used. For example, lithium transition metal complex oxide may be exemplarily represented by Li₁₊ₐNiₓCo_{yMn}_{z}M_{b}O₂ (M=at least one element selected from Al, Ti, Zr, Nb, B, Mg, and Mo, 0≦a≦0.2, 0.2≦x≦0.5, 0.2≦y≦0.5, 0.2≦z≦0.4, 0≦b≦0.02, a+b+x+y+z=1).

As the negative electrode active material, a material which can occlude and discharge lithium ions may be used. For example, a carbon material may be used. Carbon materials which can occlude and discharge lithium ions include graphite, a hardly graphitizing carbon, an easily graphitizing carbon, fiber carbon, cokes, and carbon black. Of these, the graphite is particularly preferable. As the non-carbon-based material, silicon, tin, and an alloy and an oxide having silicon and tin as primary constituent may be exemplified.

As the non-aqueous solvent (organic solvent) of the non-aqueous electrolyte, carbonates, lactones, ethers, ketones, esters, or the like may be used. Alternatively, two or more of these solvents may be used in a mixture. For example, ring carbonates such as ethylene carbonate, propylene carbonate, and butylene carbonate, or chain carbonates such as dimethyl carbonate, ethylmethyl carbonate, and diethyl carbonate may be used. In particular, the use of a mixture solvent of the ring carbonate and the chain carbonate is preferable. In addition, an unsaturated ring ester carbonate such as vinylene carbonate (VC) may be added to the non-aqueous electrolyte.

As electrolyte salts of the non-aqueous electrolyte, materials generally used as the electrolyte salt in the lithium ion secondary battery of the related art may be used. For example, LiPF₆, LiBF₄, LiCF₃SO₃, LiN(CF₃SO₂)₂, LiN(C₂F₅SO₂)₂, LiN(CF₃SO₂) (C₄F₉S0₂) , LiC(CF₃SO₂)₃, LiC(C₂F₅S0₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, or LiP(C₂O₄)F₄, or a mixture thereof may be used. Of these, LiPF₆ is particularly preferable. In addition, the dissolved amount of the electrolyte salt in the non-aqueous solvent is preferably 0.5˜2.0 mol/L.

As the separator, a porous separator made of polyolefin may be preferably used, such as polypropylene (PP) and polyethylene (PE). In particular, a separator having a 3-layer structure of polypropylene (PP) and polyethylene (PE) (PP/PE/PP or PE/PP/PE) is preferable. Alternatively, a polymer electrolyte maybe used as the separator.

The flat-shaped electrode assembly may be a layered electrode assembly in which a plurality of positive electrode plates, a plurality of the negative electrode plates, and the separator are layered.

What is claimed is:

1. A non-aqueous electrolytic secondary battery comprising:
an electrode assembly having a positive electrode plate on which a positive electrode mixture layer is formed over a surface of a positive electrode core, and a negative electrode plate on which a negative electrode mixture layer is formed over a surface of a negative electrode core; and
a non-aqueous electrolyte, wherein
the positive electrode mixture layer includes a lithium transition metal complex oxide,
the negative electrode mixture layer includes a negative electrode active material to and from which lithium ions may be introduced and extracted,
a thickness of the positive electrode plate is less than or equal to 60 μm,
a thickness of the negative electrode plate is less than or equal to 65 μm,
a ratio of a thickness of the positive electrode core with respect to the thickness of the positive electrode plate is 22˜27%, and
a ratio of a thickness of the negative electrode core with respect to the thickness of the negative electrode plate is 12˜15%.

2. The non-aqueous electrolytic secondary battery according to claim 1, wherein
the electrode assembly is a flat-shaped winding electrode assembly in which the positive electrode plate and the negative electrode plate are wound with a separator therebetween,
the non-aqueous electrolytic secondary battery further comprises:
a rectangular outer housing that has a tubular shape with a bottom, that has an opening, and that houses the electrode assembly and the non-aqueous electrolyte; and
a sealing plate that seals the opening,
the rectangular outer housing comprises a pair of large-area side walls and a pair of small-area side walls having a smaller area than the large-area side wall, and
a value of a number of layers of the positive electrode plate in the electrode assembly placed between the pair of the large-area side walls with respect to a distance between the pair of the large-area side walls is greater than or equal to 5 layers/mm.

3. The non-aqueous electrolytic secondary battery according to claim 1, wherein
an average particle size of the lithium transition metal complex oxide is 1˜12 μm,
the negative electrode mixture layer includes a carbon material as the negative electrode active material, and
an average particle size of the carbon material is 4˜15 μm.

4. The non-aqueous electrolytic secondary battery according to claim 1, wherein
a filling density of the positive electrode mixture layer is 2.2˜3.0 g/cm³, and
a filling density of the negative electrode mixture layer is 0.9˜1.5 g/cm³.

5. The non-aqueous electrolytic secondary battery according to claim 1, wherein a thickness of the flat-shaped winding electrode assembly is greater than or equal to 10 mm.

6. The non-aqueous electrolytic secondary battery according to claim 1, wherein
the positive electrode mixture layer includes an electricity conducting agent made of a carbon material, and
a content of the electricity conducting agent in the positive electrode mixture layer is greater than or equal to 5 weight %.

7. A method of manufacturing a non-aqueous electrolytic secondary battery comprising: an electrode assembly having a positive electrode plate on which a positive electrode mixture layer is formed over a surface of a positive electrode core, and a negative electrode plate on which a negative electrode mixture layer is formed over a surface of a negative electrode core; and a non-aqueous electrolyte, wherein the positive electrode mixture layer includes a lithium transition metal complex oxide, the negative electrode mixture layer includes a negative electrode active material to and from which lithium ions may be introduced or extracted, a thickness of the positive electrode plate is less than or equal to 60 μm, a thickness of the negative electrode plate is less than or equal to 65 μm, a ratio of a thickness of the positive electrode core with respect to the thickness of the positive electrode plate is 22˜27%, and a ratio of a thickness of the negative electrode core with respect to the thickness of the negative electrode plate is 12˜15%, the method comprising:
a step of applying a positive electrode mixture slurry over the surface of the positive electrode core, wherein the positive electrode mixture slurry includes the positive electrode active material, a positive electrode binding agent, a positive electrode electricity conducting agent, and a positive electrode dispersing medium, and a ratio of the positive electrode dispersing medium in the positive electrode mixture slurry is 20˜40 weight %, and
a step of applying a negative electrode mixture slurry over the surface of the negative electrode core, wherein the negative electrode mixture slurry includes the negative electrode active material, a negative electrode binding agent, and a negative electrode dispersing medium, and a ratio of the negative electrode dispersing medium in the negative electrode mixture slurry is 50˜70 weight %.

8. The method of manufacturing the non-aqueous electrolytic secondary battery according to claim 7, wherein
the positive electrode active material is a lithium transition metal complex oxide,
the positive electrode binding agent is polyvinylidene fluoride,
the positive electrode electricity conducting agent is a carbon material,
the positive electrode dispersing medium is N-methyl-2-pyrrolidone,
the negative electrode active material is a carbon material,
the negative electrode binding agent is styrene-butadiene rubber, and
the negative electrode dispersing medium is water.
